(19) United States
(12) Patent Application Publication
(10) Pub. No.: US 2026/0261089 A1
(43) Pub. Date: Sep. 3, 2026

(54) An Optical Amplifier System

(71) Applicant: Leonardo UK Ltd, London (GB)

(72) Inventors: John BARR, London (GB); Ross MACISAAC, London (GB)

(73) Assignees: Leonardo UK Ltd, London (GB); Leonardo UK Ltd, London (GB)

(21) Appl. No.: 19/163,937

(22) PCT Filed: Mar. 8, 2024
(86) PCT No.: PCT/EP2024/056275

§ 371 Date: Sep. 10, 2025

(30) Foreign Application Priority Data
Mar. 10, 2023 (GB) 2303539.7

(51) Int. Cl. H01S 3/067; H01S 3/08; H01S 3/10

(52) U.S. Cl. CPC H01S 3/06758; H01S 3/08013; H01S 3/10053; H01S 2301/03

(57) ABSTRACT

High power fibre amplifier systems avoid inadvertent generation of Stimulated Brillion Scattering (SBS) that causes optical losses and, if large enough, may damage the system. The standard active technique used to suppress SBS is to modulate the seed beam with a radio frequency line width broadening signal, e.g. white noise, to increase the spectral linewidth of the seed beam. This significantly increases the threshold power at which SBS becomes a problem by significantly reducing the coherence length. The problem accompanying a reduced coherence length is that the tolerance in variations in optical path length reduces markedly. The solution provided to this problem is to delay the line width broadening signal by predetermined amount to compensate for the difference in optical path lengths.

High power fibre amplifier systems require means to avoid inadvertent generation of Stimulated Brillion Scattering (SBS) that cause optical losses and, if large enough, may damage the system.

There are known techniques for suppression of SBS in fibre components, laser and amplifiers. These may be categorised as either passive or active techniques.

Passive techniques rely on careful design of the fibre structure or selection of suitable dopants. Examples of these techniques include core radius modulation to tailor the longitudinal acoustic frequency, introduction of optical isolators, the introduction of selected dopants into the fibre core or cladding, and periodically modulating strain within the fibre.

The standard active technique used to suppress SBS is to modulate the seed beam with a radio frequency line width broadening signal to increase the spectral linewidth of the seed beam. An electronic white noise source is commonly used to generate the electronic line width broadening signal though other techniques may also be used such as Fourier synthesis of a suitable radio frequency (RF) line width broadening signal as described in EP0730190A.

Power scaling amplifiers require the use of coherent beam combination (CBC) techniques where the output of many parallel fibre amplifiers are combined to increase the output power of a laser system. Each of the standard CBC techniques, spectral, tiled aperture and filled aperture, use active SBS suppression.

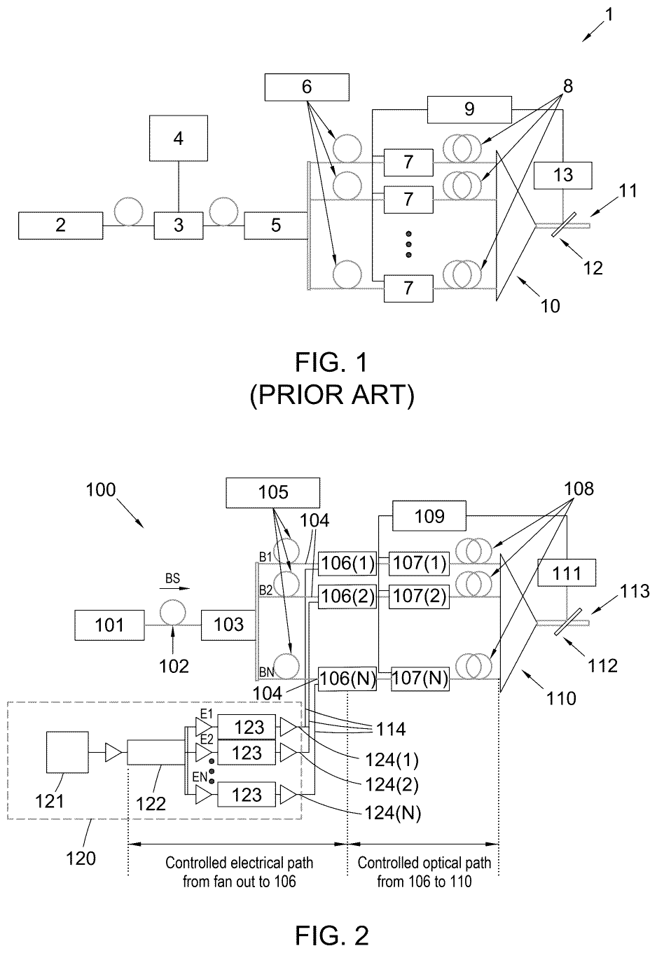

A prior art system implementing this approach is illustrated in FIG. 1.

The fibre optical amplifier system 1 comprises a seed laser 2, a primary phase modulator 3, a RF noise source 4, a fan out 5, a set of pre-amplifiers 6, a set of secondary phase modulators 7, a set of power amplifiers 8, a controller 9 and a coherent beam combiner 10.

The seed laser 2 generates a low power narrow linewidth seed beam. The seed beam is modulated by the primary phase modulator 3 to impose RF noise from the noise source 4. As a consequence of the modulation, the modulated seed beam has an increased linewidth. The modulated seed beam is divided by the fan out 5 into a set of optical beamlets each carried by a separate fibre. The set of pre-amplifiers 6 amplify each optical beamlet of the set. After pre-amplification, the set of optical beamlets are modulated by the set of secondary phase modulators 7 under control from the controller 9. The secondary phase modulators are used for three purposes, (1) to correct for low frequency, wavelength scale path length changes, for example, as a result of thermal changes in refractive index in the fibre amplifiers; (2) to provide phase corrections for other reasons, for example corrections enabling phase lock at target (target in the loop (TIL)) capability; and (3) to provide electronic beam steering by adjusting the phase across the combined beam.

After exiting the fibre tip of their respective fibre, and normally after passing through an endcap or a collimator, the set of optical beamlets are coherently combined by the coherent beam combiner 10. The coherent beam combiner 10 may be based on a tiled configuration, a filled configuration, or a mixed configuration.

The output of the coherent beam combiner 10 is a free space beam 11. A pick off mirror 12 is configured to direct a portion of the free space beam 11 to a diagnostic system 13 that outputs characteristics of the beam 11 to the controller 9. The controller 9 uses the output of the diagnostic system 13 to adjust the secondary phase modulators 7 to ensure the beam 11 has a phase that is coherent across the beam width.

The coherence length, L_{Cs}, for the seed beam is given by:

$${L}_{Cs} = \frac{c \sqrt{2} ln 2}{π Δ v} = 0.312 \frac{c}{Δ v}$$

Where c is the speed of light and Δν is the linewidth.

The tolerance for any variations between the optical path lengths is commonly considered to be

$$\frac{{L}_{Cs}}{5} .$$

The optical path length of each beamlet between the fan out 5 and coherent beam combiner 10 is often many tens of metres long; the expected variation between the path lengths is usually less than a few meters. For a system where the maximum optical path length difference is 1 m, the maximum seed laser linewidth is in the region of 93.6 MHz.

Seed lasers providing a seed beam with linewidth far smaller than 93.6 MHz are readily available. For example, a seed laser providing a 5 kHz seed beam linewidth gives rise to a coherence length, L_{Cs}, for the seed beam of 18.722 km. This value of L_{Cs} is so much larger than the expected variation in optical path lengths that the seed beam would, if not modulated by the primary phase modulator 3, remain coherent. However, the modulated seed beam output from the primary phase modulator 3 may typically have a bandwidth in the region of 20 GHz to 30 GHz (special consideration has to be given to linewidths larger than twice the Brillouin frequency shift of about 13 GHz in fused silica). This significantly increases the threshold power at which SBS becomes a problem by significantly reducing the coherence length. A bandwidth of 30 GHz has a coherence length of ~3 millimetres.

As a result of the reduced coherence length, the tolerance in variations in optical path length reduces markedly. For a 30 GHz bandwidth L_{Cs} drops to:

$$\frac{3 mm}{5} = 0.6 mm .$$

In other words, each fibre channel providing an optical path between the fan out 5 and the combiner 10 must have a total length that is the same within a tolerance of 0.6 mm. This requirement poses a significant manufacturing and measurement challenge. Typically the length of each of the fibre channels is determined, for example by physically measuring the length of the fibre as the build process is carried out; by using time domain reflectometry to directly measure the optical length of each amplifier, or by measuring the time of flight of a short optical pulse through each amplifier. This is followed by an optical path length equalisation process activity, for example removing or adding fibre to the amplifier or by increasing or shortening any free space distance between the seed laser and the location where beam combination takes place.

U.S. Pat. No. 11,588,556B1 takes a different approach to the above. It uses an optical heterodyne technique to adjust the timing of the RF SBS suppression signal to compensate for optical path length mismatch. This obviates the need to measure and cut the fibre carriers but necessitates a significantly more complex electronic and optical solution, and thus is likely to be less reliable and less scalable compared with the solution of FIG. 1 in real world application.

According to a first aspect of the invention there is provided an optical fibre amplifier system comprising:
(i) an optical fan out adapted to receive and split a coherent optical beam into a set of multiple optical beams;
(ii) a set of optical fibre transmission lines, each transmission line of the set of optical fibre transmission lines adapted to carry a different optical beam of the set of multiple optical beams; each optical fibre transmission line providing a different optical path length from the others of the set;
(iii) each optical fibre transmission line comprising a separate optical fibre amplifier, configured to amplify the optical beams carried by the transmission line;
(iv) a coherent beam combiner arranged to combine the set of multiple optical beams outputted from the set of optical fibre transmission lines to provide a combined output beam that is substantially both spatially and temporally coherent;
and
(v) a radio frequency Stimulated Brillouin Scattering (RF SBS) suppression signal generator means (Generator);
characterised in that:
the Generator is configured to generate a set of RF SBS suppression signals (Signals), each Signal of the set being time offset from each of the other Signals of the set;
(vi) a set of electro-optic phase modulators, each electro-optic phase modulator configured to phase modulate a different one of the Signals of the set of Signals onto a different beam of the set of multiple beams;
the value of the time offset of each Signal selected to compensate for the different optical path lengths of the fibre transmission lines to cause the Signal imposed on each of the beams at the point they are combined by the coherent beam combiner to be substantially temporally aligned.

The time offsets are able to compensate for variation in the path lengths of the optical fibre transmission lines at scales of mm to metres, obviating the need to precisely cut each optical fibre to the same length or subsequently equalise the fibre lengths through addition or removal of fibre.

In one embodiment the RF SBS suppression signal generator may comprise (a) a RF signal source configured to output an RF signal, (b) a divider to divide the RF signal to provide the set of RF SBS suppression signals; and (c) a bank of true time delays, each true time delay of the bank of true time delays adapted to impose a true time delay onto a different RF SBS suppression signal. Each true time delay device may be implemented separately by one or more of delay lines and/or true time delay chips.

Typical narrow linewidth SBS thresholds in fibre amplifiers are measured to be of the order of 100 W. Operation at 2 kW, which is 20 times the narrow linewidth SBS threshold, requires a linewidth increase of the input signal to 20 times the Brillouin linewidth; that is 10 GHz to 20 GHz. Thus it is favourable that each beam of the set of multiple beams output from its electro-optic phase modulator has a bandwidth equal or exceeding 20 GHz.

It is known that a spectral broadening process based on a suitably filtered white noise electrical source in the RF region is effective at suppressing SBS. Thus, the RF signal source may comprise one or more of a white noise source (WNS) or a pseudo random RF noise source, e.g. a pseudo-random binary sequence (PBRS). Where so, the divider may be arranged to divide an RF white noise signal or pseudo random RF noise signal

However, it is not necessary for the RF SBS suppression signal to be random or pseudo random. A signal suitable for RF SBS suppression can instead be generated by combining a suitable selection of different frequencies, utilising the effects of cross modulation to provide a fuller spectrum.

In fact, this process may be used as an alternative way to provide the necessary time delays as an alternative to using a true time delay. In other words, the Generator may be configured to synthetically generate each Signal of the set individually with its desired time delay.

As such, the Generator may comprise: means to generate a set of frequencies; a set of signal generators each adapted to receive the set of frequencies; each signal generator adapted to apply a weighting to (e.g. the amplitude and/or phase of) each RF frequency and to combine the weighted frequencies to generate a different one of the Signals of the set of time offset Signals.

Generating the time delays synthetically has the advantage that the value of each time delay can be easily adjusted during operation, e.g. to compensate for parametric variations of each of the each of the physical paths.

The system may include a seed laser to provide the coherent optical beam. The coherent optical beam may have a linewidth in the region of 5 kHz. It will be appreciated that seed lasers with other linewidths could be used instead.

The combined output beam is preferentially a free space beam. The system may comprise a diagnostics system. The diagnostic system may include a sensor arranged to receive at least a portion of the combined output beam, and the diagnostic system configured to output one or more signals indicative of a characteristic of the combined output beam, e.g. degree of spatial and/or temporal coherence.

The system may comprise a controller adapted to receive the signals from the diagnostic system and to output an electrical control signal to the Generator. The generator may be adapted to use the control signal to alter the time offset of one or more of the RF SBS suppression signals relative to the others, e.g. to increase the degree of spatial and/or temporal coherence of the output beam from the coherent beam combiner.

The amplifier system may further comprise means to generate a set of secondary phase modulation signals and to modulate a different one of each of the set of secondary phase modulation signals onto a different beam of the set of multiple beams to compensate for nano-meter scale changes in optical path length, e.g. for one or more of (1) correcting low frequency, wavelength scale path length changes, for example, as a result of thermal changes in refractive index in the fibre amplifiers; (2) to provide phase corrections for other reasons, for example corrections enabling phase lock at target (TIL); and (3) to provide electronic beam steering by adjusting the phase across the beam.

The controller may be adapted to generate the set of secondary phase modulation signals.

The set of secondary phase modulation signals may be modulated onto the set of multiple beams by a bank of secondary phase modulators. Alternatively, though less preferred, they may be imposed onto the set of multiple beams by the (first) set of electro-optic phase modulators.

The need for SBS suppression is of most value with high power amplifiers. As such, the amplifier system may be adapted for normal operation with a beam power of each of the multiple optical beams equal or exceeding 200 W.

The invention may also be expressed in terms of a method and thus according to a second aspect of the invention there is provided a method of suppressing Stimulated Brillouin Scattering in an optical amplifier:
the method comprising:
   (i) generating a set of RF SBS suppression signals (Signals), each Signal of the set being time offset from each of the other Signals of the set;
   (ii) modulating each Signal of the set onto a different beam of a set of multiple beams; each beam propagating along a different optical fibre transmission line, of a set of optical fibre transmission lines;
   (iii) combining the set of multiple optical beams outputted from the set of optical fibre transmission lines to provide a combined output beam that is substantially both spatially and temporally coherent; and
   wherein the value of the time offset of each Signal is selected to compensate for differences between the optical path lengths of the optical fibre transmission lines to cause the Signal imposed on each of the multiple optical beams at the point they are combined to be substantially temporally aligned.

The invention will now be described by way of example with reference to the following Figures in which:

FIG. 1 is a schematic of a prior art high power fibre amplifier system;

FIG. 2 is a schematic of a fibre amplifier system;

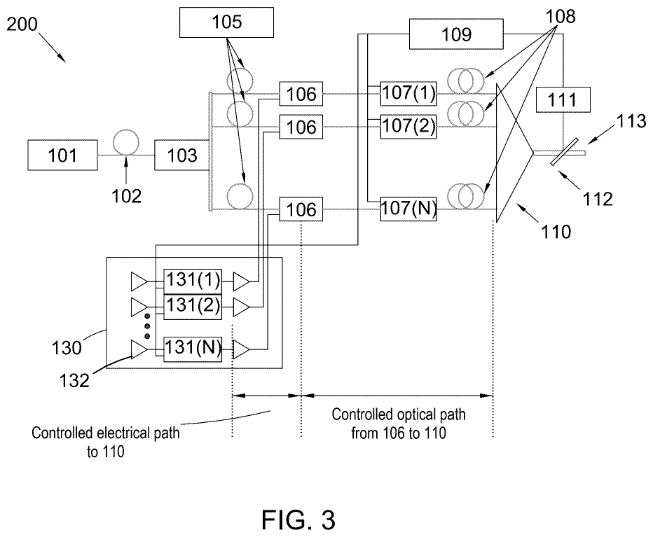

FIG. 3 is a schematic of a variant embodiment of fibre amplifier system; and

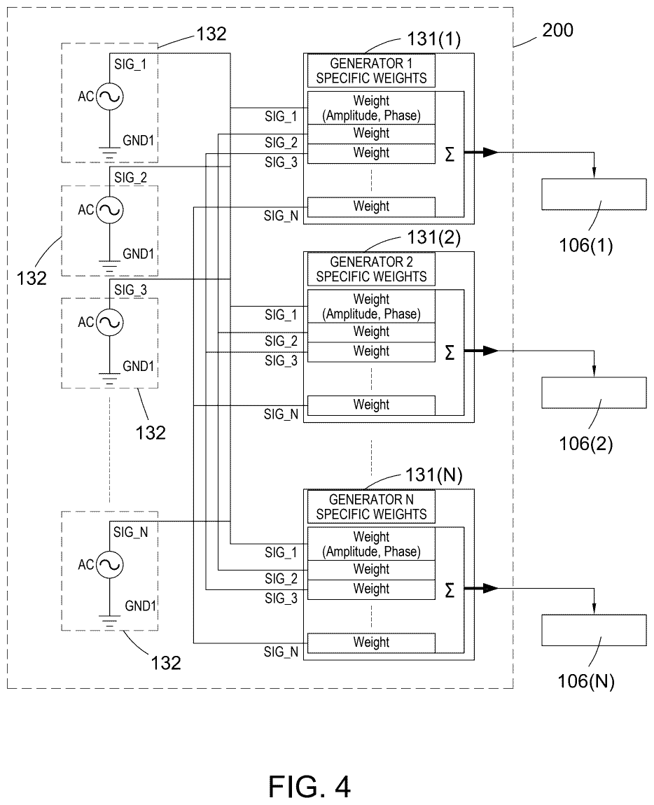

FIG. 4 is a schematic of the signal generator means of the variant embodiment of FIG. 3.

With reference to FIG. 2, there is illustrated a fibre optical amplifier system 100 comprising a seed laser 101 adapted to provide a continuous wave (CW) seed beam BS carried by an optical fibre link 102 to an optical fan out 103 that divides out the seed beam BS substantially equally into N beamlets B1-BN about N fibre channels 104, one beamlet per channel 104.

The system 100 further comprises: a set of fibre optical pre-amplifiers 105, one per channel 104; a first set of phase modulators 106, one per channel 104; a second set of phase modulators 107, one per channel 104; a set of optical power fibre amplifiers 108, one per channel 104; a controller 109; a coherent beam combiner 110; a diagnostic system 111; a pick off mirror 112; and a signal generator means 120.

The seed laser 101 is configured to provide a seed beam BS with a linewidth that provides a coherence length significantly exceeding the maximum range of optical path length differences expected between the fibre channels 104 between the fan out 3 and coherent beam combiner 110. Lasers with a linewidth of 5 kHz are suitable for this purpose.

Each pre-amplifier 105 amplifies a different beamlet B1-BN to compensate for power loss resulting from the division of the seed beam BS by the fan out 103, as well as to improve the efficiency of the power amplifiers 108. As such, the pre-amplifiers 105, although preferred, are optional.

Following preamplification, each beamlet B1-BN is modulated by a different one of the phase modulators 106(1)-106(N) to impose a linewidth broadening signal received from the signal generator means 120. Each broaden beamlet outputted from its respective phase modulator 106(1)-106(N) has a frequency linewidth between 20 GHz and 30 GHz inclusive.

The beamlets of each channel 104 are coherently combined by the coherent beam combiner 110. Typically a collimator is provided at the end of each fibre channel 104 to collimate each beamlet before they are combined by the coherent beam combiner 110. The coherent beam combiner 110 may combine, based on a tiled configuration, a filled configuration or a mixed configuration, each of which are known to those skilled in the art. The output of the coherent beam combiner 110 is a free space beam 113.

The pick off mirror 112 is arranged to redirect a portion of the free space beam 113 to the diagnostics system 111. The diagnostics system 111 comprises one or more electro-optical sensors to receive the redirected beam portion from the pick off mirror 112, and processing means to characterise properties of the received beam including its temporal and spatial coherence across the beam width using techniques familiar to those skilled in the art. Electrical signals indicative of the beam characteristics are outputted by the diagnostic system 111 to the controller 109.

The controller 109 uses the signals from the diagnostic system 111 to generate a set of secondary phase modulation signals. Each phase modulator 107 of the secondary set of phase modulators are adapted to receive a different secondary phase modulation signal of the set for one or more of the three purposes described in relation to the prior art system of FIG. 1 namely: (1) to correct for low frequency path length differences (optical wavelength scale) between the beams, resulting from changes in refractive index in the fibre amplifiers; (2) to provide phase corrections for other reasons, for example corrections enabling phase lock at target (TIL); and (3) to provide electronic beam steering by adjusting the phase across the beam.

The signal generator means 120 comprises a radio frequency (e.g. GHz), noise source 121, a RF splitter 122, a bank of true time delay devices 123 and a set of electrical outputs 124(1)-124(N), each output 124(1)-124(N) is connected to a different modulator 106 of the first set of phase modulators 106(1)-106(N) through separate electrical channels 114.

The noise source 112 generates a Radio Frequency (RF) noise signal that is divided by the RF splitter 113 (e.g. implemented by one or more RF amplifiers and RF splitters) about N electrical channels E1-EN. The noise source may be a white noise source implemented, for example, by a digital signal processor. The RF noise signal on each electrical channel E1-EN is subjected to a true time delay by a different one of true time delay devices 123. The delayed noise signals carried on the set of electrical channels E1-EN together constitute a set of linewidth broadening signals. Each signal of the set is outputted at different one of the outputs 124(1)-124(N) for receipt and imposition onto a different one of the beamlets B1-BN by a different modulator 106 of the first set of modulators 106(1)-106(N).

Each true time delay device 123 is separately configured to impart a time delay with a value δt selected to compensate for the different optical path lengths of the fibre channels 104 between the phase modulators 106 and the coherent beam combiner 110 so that the linewidth broadening signal modulated on each beamlet B1-BN is substantially temporally aligned at the point the beamlets B1-BN are combined. As such the value of δt imparted by each true time delay device 123 likely differs from the others of the bank.

For example, if it is determined that optical channel 104(1) is the longest of the N optical channels, the true time delay devices 123 associated with each of the other optical channel 104(2)-104(N) would be configured to impart an independent true time delay to the RF noise signal carried on its respective electrical channel E2-EN sized to compensates for the degree to which its associated optical channel is shorter than optical channel 104(1).

Configuring the length of the time delay required for each channel E1-EN can be carried out as part of a calibration process during manufacture of the amplifier system 100.

It may that one or more of the optical fibre channels 104 are sufficiently similar in length that the time delay value associated with these channels is the same. That value may be zero.

The true time delay devices 123 may be implemented by dedicated true time delay lines or true time delay chips. Alternatively, the true time delay may be implemented by different physical lengths of electrical channel between the splitter 122 and modulators 106.

The process of preconfiguring the time delays may comprise measuring the length of each optical channel, and then using these measurements to preconfigure a time delay value for each channel E1-EN.

Measuring the length of each optical channel may be performed in a variant of ways, including, for example, using time domain reflectometry to directly measure the optical length of each channel, or by measuring the time of flight of a short optical pulse through each channel.

The measurements are then used to determine a time delay value for each line. Each true time delay device 123 is then preconfigured to provide the determined time delay for its respective channel.

FIG. 3 illustrates a fibre amplifier system 200 with a variant signal generator means 130 comprising a bank of Fourier synthesised signal (FSS) generators 131(1)-131(N). Each FSS 131 is adapted to generate a different one of the set of the linewidth broadening signals for output to the first set of modulators 107.

With reference to FIG. 4, the variant signal generator means 130 further comprises a bank of frequency sources 132. Each frequency source 132 is adapted to output an electrical signal of a different frequency.

Each FSS generator 131 is adapted to receive all of the frequencies from the signal sources 132 and combine (sum) the frequencies to provide a separate linewidth broadening signal. In other words, each linewidth broadening signal of the set is synthesised by a separate Fourier series by a different one of the FSS generators 131.

The frequencies provided by the bank of frequency generators 132 are each a positive prime integer multiple of a selected fundamental frequency. The fundamental frequency need not itself be a prime number. This provides a set of input frequencies to each FFS generator 131 that are not harmonically closely related, i.e. don't have common factors, to ensure the frequency spectrum components of the resulting linewidth broadening signal are well spread to avoid coherent cross modulation terms.

The linewidth of the produced spectrum is proportional to the signal frequency and the modulation amplitude, so higher prime frequencies, e.g. above 2000 are preferable to lower prime number frequencies. For example, a 20 GHz wide optical spectrum having a fundamental frequency of 1 MHz can be achieved combining the frequencies of: 2081 MHz, 2377 MHz, 2851 MHz, and 3001 MHz; 2081, 2377, 2851 and 3001 each being a prime integer multiple of 1. Further information on the implementation can be found for example in EP0730190A.

Additionally, each FSS generator 131 is configured to apply a separate weighting for each of the amplitude and phase for each frequency before combination. Each FSS generator 131 may hold its own weighting values, or they may be provided by the controller 9. The set of weighting applied by each FSS generator 131 is based on the required equivalent real time delay value for the signal to be generated. The manner to implement the weighting to generate a specific time delay value will be known to those skilled in the art.

Equivalently, but less efficiently from a processing perspective, all the FSS generators 131 may apply identical weights but are initiated independently in sequence by the controller 9 with delays in starting time between the generators 131 corresponding to the real time delay required.

Calibration of the time delay values associated with each channel 104 is initially undertaken before the system 100 is first put into service. Initially the system 100, 200 is run without generating and/or modulating the line broadening signal onto the beamlets B1-BN to calibrate the signals to the second set of phase modulators 107 to correct for low frequency, optical wavelength scale path length differences. A portion of the beam 113 output from the coherent beam combiner 110 is redirected by the pick off mirror 112 to the diagnostic system 111. The characteristics of the beam 113, specifically its coherence, is outputted to the controller 109 that uses the output to adjust one or more of the second set of phase modulators 107. For example, the diagnostic system 111 may be adapted to output one or more error values corresponding to the extent to which beam 113 is incoherent in one or more respects. The controller 9 adjusts each of the electrical modulating signals imposed by the secondary modulators 107, e.g. based on a hill climbing algorithm, to minimise the error value(s).

Following this first stage of calibration, the set of line broadening signals, without a time delay yet being applied, is modulated onto the beamlets via the first set of modulators 106. Differences in the optical path lengths of the channels 104 between the first modulators 106 and coherent beam combiner 110 result in the temporal misalignment of the line broadening signal between the channels 104 at the point the beams are combined by the coherent beam combiner 110 that manifests as an increase in incoherence of the free space beam 113. This is expressed by an increase in the error value(s) outputted by the diagnostic system 111 to the controller 109.

For the system 100 of FIG. 2 that utilises true time delays, the true time delay value of each TTD 123 is adjusted, e.g. according to a hill climbing algorithm, until the error value is below a preferred threshold value.

For the system 200 of FIGS. 3 and 4, calibration is made through adjusting one or more of the weighting values applied by each generator 123 independently from the others. Adjustment may be automated through the transmission of control signals conveying weighting information from the controller 9 to each generator 123 via control lines.

The seed beam BS need not be continuous wave so long as it has a pulse length greater than the time the amplifiers 108 are switched on.

The functions of the first and second set of modulators 106 107 may instead be undertaken by a single set of modulators.

Passive SBS suppression techniques may additionally be employed within the laser systems 100, 200 described above.

Alternative techniques to that described may be used or become known in future to generate the set of time delayed RF SBS suppression signals.

1. An optical fibre amplifier system comprising:
(i) an optical fan out configured to receive and split a coherent optical beam into a set of multiple optical beams;
(ii) a set of optical fibre transmission lines, each transmission line of the set of optical fibre transmission lines being a to carry a different optical beam of the set of multiple optical beams, each optical fibre transmission line providing a different optical path length from the others of the set;
(iii) each optical fibre transmission line including a separate optical fibre amplifier, configured to amplify the optical beams carried by the transmission line;
(iv) a coherent beam combiner arranged to combine the set of multiple optical beams outputted from the set of optical fibre transmission lines to provide a combined output beam that is substantially both spatially and temporally coherent;
and
(v) a radio frequency Stimulated Brillouin Scattering (RF SBS) suppression signal generator means (Generator),
wherein
the Generator is configured to generate a set of RF SBS suppression signals (Signals), each Signal of the set being time offset from each of the other Signals of the set by a pre-configured value;
(vi) a set of electro-optic phase modulators, each electro-optic phase modulator being configured to phase modulate a different one of the Signals of the set of Signals onto a different beam of the set of multiple beams; and
the pre-configured value of the time offset of each Signal being selected to compensate for different optical path lengths of the fibre transmission lines to cause the Signal imposed on each of the beams at a point they are combined by the coherent beam combiner to be substantially temporally aligned.

2. An optical amplifier system according to claim 1, wherein the Generator comprises:
(a) a RF signal source configured to output an RF signal;
(b) a divider to divide the RF signal to provide the set of Signals; and
(c) and a bank of true time delays, each true time delay of the bank of true time delays adapted to impose a true time delay onto a different Signal of the set.

3. An optical amplifier system according to claim 1, wherein the Generator comprises:
means to generate a set of frequencies; a set of signal generators each configured to receive the set of frequencies; each signal generator being adapted to apply a weight to each RF tone and to combine weighted frequencies to generate a Signal of the set of Signals having a time offset that is different from the other signals of the set of signals.

4. An optical amplifier system according to claim 1, comprising:
a seed laser to provide the coherent optical beam.

5. A method of suppressing Stimulated Brillouin Scattering in an optical amplifier:
the method comprising:
(i) generating a set of RF SBS suppression signals (Signals), each Signal of the set being time offset from each of other Signals of the set;
(ii) modulating each Signal of the set onto a different beam of a set of multiple beams, each beam propagating along a different optical fibre transmission line, of a set of optical fibre transmission lines;
(iii) combining the set of multiple optical beams outputted from the set of optical fibre transmission lines to provide a combined output beam that is substantially both spatially and temporally coherent; and
wherein a value of the time offset of each Signal is selected to compensate for differences between optical path lengths of the optical fibre transmission lines to cause the Signal imposed on each of the multiple optical beams at a point they are combined to be substantially temporally aligned.
